(19) United States
(12) Patent Application Publication
(10) Pub. No.: US 2010/0125576 A1
(43) Pub. Date: May 20, 2010

(54) USER ORIENTED INFORMATION SYSTEM AND METHOD OF CONTROLLING THE USER ORIENTED INFORMATION SYSTEM

(75) Inventors: Park Sehyun, Seoul (KR); Kim Gwangyeon, Seoul (KR); Kim Yong, Seoul (KR); Uhm Yoon Sik, Seoul (KR); Hwang Zi on, Seoul (KR); Jin Ho Jin, Seoul (KR)

Correspondence Address: AMPACC Law Group, 3500 188th Street S.W., Suite 103, Lynnwood, WA, 98037, US

(73) Assignee: Chung-Ang University Industry-Academy Cooperation Foundation, Seoul (KR)

(21) Appl. No.: 12/569,126

(22) Filed: Sep. 29, 2009

(30) Foreign Application Priority Data
Nov. 17, 2008 (KR) 10-2008-0114002
Apr. 22, 2009 (KR) 10-2009-0035061

(51) Int. Cl. G06F 17/30

(52) U.S. Cl. 707/732; 707/E17.059; 707/783

(57) ABSTRACT

Provided is a user oriented information system that may retrieve user oriented information or may provide the user oriented information to a mobile device, and a method of controlling the user oriented information system. The user oriented information system may detect the mobile device, detect an information request of the mobile device, and provide a content corresponding to the information request to the mobile device based on a profile of the mobile device.

### CROSS-REFERENCE TO RELATED APPLICATIONS

This application claims the benefit of Korean Patent Application No. 10-2008-0114002, filed on Nov. 17, 2008, and Korean Patent Application No. 10-2009-0035061, filed on Apr. 22, 2009, in the Korean Intellectual Property Office, the disclosures of which are incorporated herein by reference.

### BACKGROUND

1. Field of the Invention

Embodiments of the present invention relate to a user oriented information system and a method of controlling the user oriented information system. More particularly, embodiments of the present invention relate to a user oriented information system that may provide user oriented information to a mobile device and thereby may more effectively utilize the mobile device, and a method of controlling the user oriented information system.

2. Description of the Related Art

With the development of information technologies, various types of services such as an information search service based on an Internet network server, a streaming service of providing multimedia contents in real time, and the like are currently provided. Representative information search portal service providers such as Google, Naver, and the like provide an information search service focus on a user convenience, instead of providing a typical information search service. However, the information search service provided by the above portable service providers may categorize pre-retrieved information into user interest fields, select the categorized information, and provide the selected information, instead of providing a user oriented information search service. Also, in the case of the conventional information search service, it may be difficult for users to retrieve a context, a content, and the like. Generally, when a user uses a computer, the user may use a search indexing program for an information search. However, in the case of a mobile device, the user may not use the search indexing program for the information search. A file server, a network direct attached storage (NDAS) for a home network or a small company, and the like may only provide a search service based on a File Transfer Protocol (FTP).

### SUMMARY

An aspect of the present invention provides a user oriented information system that may retrieve user oriented information or may provide the user oriented information to a mobile device and thereby may more effectively utilize the mobile device, and a method of controlling the user oriented information system.

Another aspect of the present invention also provides a user oriented information system that may utilize various types of devices via a home personal portal system that enables an interoperation between a mobile communication network and a wired network, and a method of controlling the user oriented information system.

Another aspect of the present invention also provides a user oriented information system that may perform real-time transcoding for a content based on a performance of a device accessing a personal portal system and may also automatically convert a content to a form suitable for a user using the personal portal system, and a method of controlling the user oriented information system.

According to an aspect of the present invention, there is provided a system for user oriented information, the system including: an access management unit that detects an access of a mobile device to receive a request for user interest information from the mobile device; a content management unit that manages a content corresponding to the user interest information; and a conversion management unit that converts the content to a form to be provided to the mobile device; and a control unit that controls an overall operation of the user oriented information system.

In this instance, the user oriented information system may further include a network interface unit that supports the access of the mobile device using the user oriented information system.

Also, the user oriented information system may further include a profile management unit that detects and manages a profile of the mobile device.

Also, the content management unit and the profile management unit may be provided in a form of a database.

Also, the conversion management unit may perform real-time transcoding of a content corresponding to the user interest information to a form suitable for the mobile device or to a form desired by a user.

Also, the control unit may compare the content corresponding to the user interest information with a profile of the mobile device. When the content corresponding to the user interest information is in a form unsuitable for the mobile device, the control unit may control the conversion management unit to perform real-time transcoding of the content corresponding to the user interest information to a form suitable for the mobile device.

According to another aspect of the present invention, there is provided a method of controlling a user oriented information system that provides user oriented information to a mobile device of a user according to a control of a processor, the method including: detecting an access of the mobile device; receiving an information request from the mobile device; receiving, from a peripheral content storage, a content corresponding to the information request of the mobile device; comparing the content with a profile of the mobile device to transcode the content based on information of the profile, when transcoding is determined to be performed; and providing the transcoded content to the mobile device.

### EFFECT

According to embodiments of the present invention, it is possible to perform automatic transcoding according to a profile of a mobile device. Specifically, it is possible to perform a one-source-multi-use function.

Also, according to embodiments of the present invention, it is possible to provide optimal information for a user regardless of where the user is located.

Also, according to embodiments of the present invention, it is possible to utilize a user oriented information system for a personal Internet knowledge space such as a blog and the like, without a restriction to a particular portal site or service, and to utilize the user oriented information system as various home gateways such as a Voice over Internet Protocol (VoIP), an Internet fax, and the like.

Also, according to embodiments of the present invention, there may be provided an information system and a method of controlling the information system that may extend a content storage. Accordingly, the information system and the method of controlling the information system may be adopted for a home, a small office home office (SOHO), a corporation, and the like.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a user oriented information system according to an embodiment of the present invention;

FIG. 2 is a diagram illustrating an example of an ontology modeling applicable in a user oriented information system according to an embodiment of the present invention; and

FIG. 3 is a flowchart illustrating a method of controlling a user oriented information system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

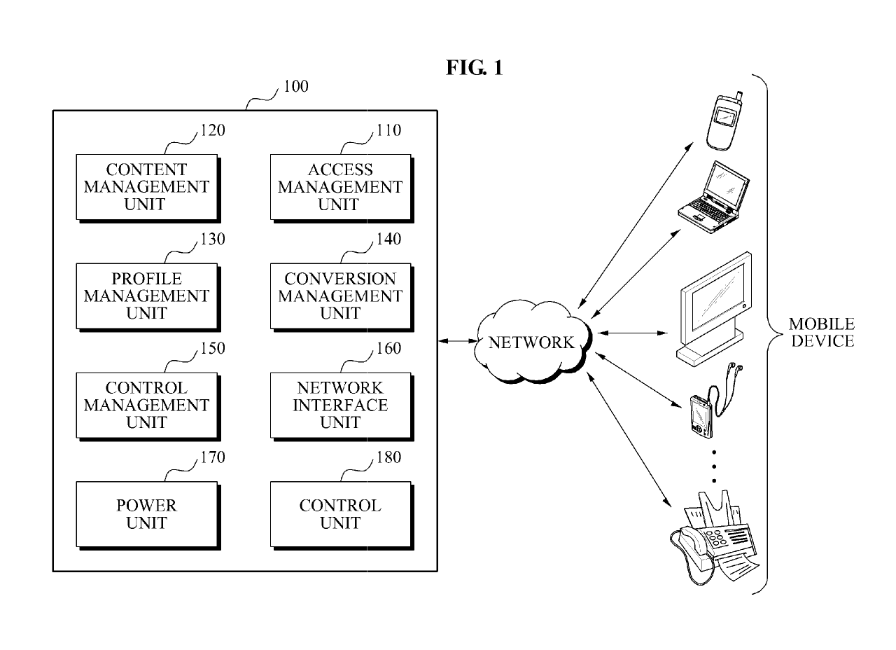

FIG. 1 is a block diagram illustrating a configuration of a user oriented information system 100 according to an embodiment of the present invention.

Referring to FIG. 1, the user oriented information system 100 includes an access management unit 110, a content management unit 120, a conversion management unit 140, and a control unit 180. Also, the user oriented information system 100 may further include a profile management unit 130, a control management unit 150, a network interface unit 160, and a power unit 170. Also, the user oriented information system 100 may further include a memory (not shown) that stores profile information of a mobile device of a user and a content to be provided to the mobile device.

The access management unit 110 may manage an access of the mobile device to the user oriented information system 100. The access management unit 110 may maintain and manage access information such as specifications of the mobile device, an Internet Protocol (IP) address thereof, an access time thereof, and the like. The access management unit 110 may include a server module that may detect the access by the mobile device that is connected to the user oriented information system 100 to make a request for the information, and may detect and maintain a request for the user oriented information. Here, user interest information that the user desires to use may be registered in the mobile device. Examples of the user interest information may include information regarding weather, traffic, world time, stocks, advertisements of preferred products, and the like. The access management unit 110 may receive, from the mobile device, the profile of the mobile device and the user interest information, and may store and manage the received profile of the mobile device and the user interest information.

According to an embodiment of the present invention, the user oriented information system 100 may access an IP network via the access management unit 110. When there is a request for an access of a mobile device of a registered user and information, the user oriented information system 100 may provide user oriented information to the mobile device of the registered user. Here, the IP network accessed via the access management unit 110 may include a femtocell interoperating with an external mobile communication network, a high speed Internet network, and the like. The user oriented information corresponds to the user interest information and indicates that information requested from the mobile device is provided to be suitable for the user. Depending on embodiments, the user oriented information and the user interest information may have the same definition.

The content management unit 120 may detect and manage a peripheral content storage (not shown) that is connected to the user oriented information system 100. In this instance, the content management unit 120 may retrieve contents that may be used by the user oriented information system 100, or peripheral devices maintaining contents to be provided to the mobile device, and manage address information of the peripheral devices, a list of contents, whether to update the contents, and the like. Also, the content management unit 120 may detect whether the contents that may be used by the user oriented information system 100 or the contents to provide for the mobile device are being used in other places or may be provided.

Also, a content to be stored in the peripheral content storage may be stored with metadata to make it possible to retrieve the content via the IP network. The metadata may include index information, creator information, source information, abstract information, coding information, and the like, regarding the content. Accordingly, the content management unit 120 may retrieve the peripheral devices that maintain the content based on the metadata, and approach the content stored in the peripheral content storage.

The profile management unit 130 may detect and manage the profile of the mobile device accessing the user oriented information system 100. The profile of the mobile device may be received from the mobile device accessing the user oriented information system 100 to the access management unit 110, and may be transferred from the access management unit 110 to the profile management unit 130. The profile of the mobile device denotes various types of information associated with the mobile device, and may include various types of information according to a purpose and a type of the mobile device.

The content management unit 120 and the profile management unit 130 may be configured using a form of a medium for a database to thereby manage contents for a user and the profile of the mobile device. Here, the medium of the database may be in the form of a memory, a disk, and the like. The type of the medium is not particularly limited and thus various types of media may be adopted.

The conversion management unit 140 may automatically support real-time transcoding of a content according to the request from the mobile device. Specifically, the conversion management unit 140 may compare various types of multimedia content information, stored in the peripheral content storage, with requested information that is transferred via the mobile device, and may transcode a corresponding multimedia content to a form suitable for the mobile device or a form desired by the user. Also, the conversion management unit 140 may transcode the multimedia content according to a control signal. The control signal may be generated based on profile information of the mobile device that is verified via the profile management unit 130. Here, the transcoding indicates converting of the multimedia content or the requested information to various types of information desired by the user, for example, to music of which a bitrate is adjusted, a multimedia file, a voice based on a text file, and the like. According to an embodiment of the present invention, when a capacity of a multimedia content to be provided to the mobile device or a type of a codec used for creation of the multimedia content is unsuitable for the mobile device, the user oriented information system 100 may transcode the multimedia content in real time and provide the transcoded multimedia content to the mobile device.

Examples of the mobile device may include a cellular phone, a personal digital assistant (PDA), a smart terminal, a miniature mobile device with a limited function, a dedicated motion picture or Internet mobile device, an Internet Protocol TV (IPTV) terminal, a notebook, and the like. Therefore, the conversion management unit 140 may include a plurality of modules in order to enable transcoding of the content according to a type of the mobile device.

The control management unit 150 may display a control status of the user oriented information system 100 on a display (not shown), and enables the user to control the user oriented information system 100.

The network interface unit 160 may support an access of the user. Specifically, the network interface unit 160 may access the network to be connected to the mobile device of the user.

The power unit 170 may supply a power to the user oriented information system 100.

The control unit 180 may control an overall operation of the user oriented information system 100, and may control processing of information based on the profile of the mobile device. For example, the control unit 180 may generate the control signal based on profile information of the mobile device, and may provide the generated control signal to the conversion management unit 140. A request for the content and information from the mobile device may be transferred to the control unit 180. The control unit 180 may use the request for the content and information as reference information to control the content management unit 120 and the conversion management unit 140. The control unit 180 may include a programmable processor.

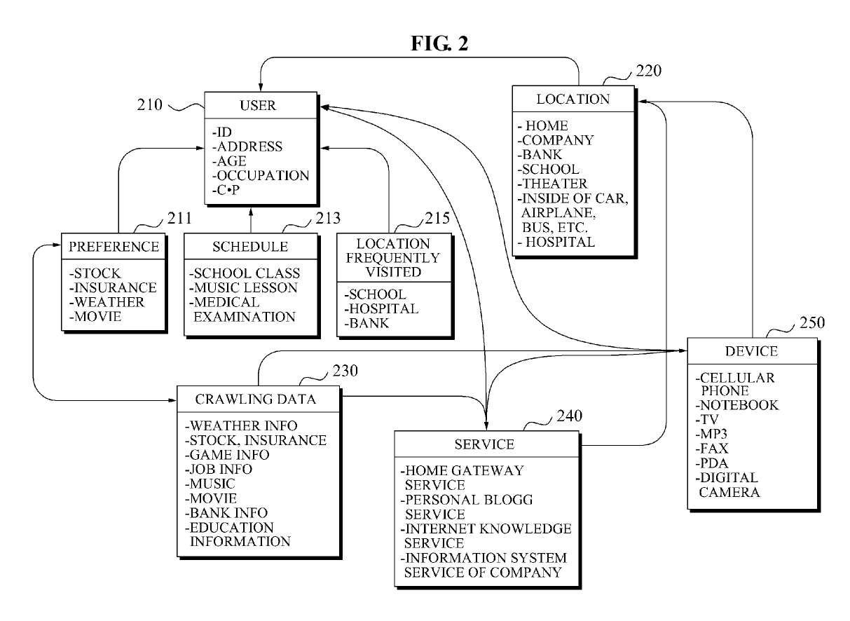

A user oriented information system according to an embodiment of the present invention may be applicable to various types of services. For example, the user oriented information system may be applicable in a home gateway service, a company, a SOHO system, an automatic movement unit, and the like. The user oriented information system according to an embodiment of the present invention may provide various types of expendabilities by referring to, for example, an ontology modeling of FIG. 2.

FIG. 2 is a diagram illustrating an example of an ontology modeling applicable in a user oriented information system according to an embodiment of the present invention. Referring to FIG. 2, the ontology modeling may be classified into five classes for, for example, a user 210, a location 220, crawling data 230, a service 240, and a device 250. The class for the user 210 may be associated with identification (ID) information of a user and may also include subclasses for a preference 211, a schedule 213, and a location frequently visited 215. However, the present invention is not limited thereto. The subclass for the preference 211 may be associated with the class for the crawling data 230, and be used to crawl information desired by the user and to provide the crawled data. Also, the classes for the user 210, the location 220, and the crawling data 230 may be networked with each other and thereby may be provided to the device 250. The class for the service 240 shows an example of services adopting user oriented information. Referring to FIG. 2, the service 240 may include a home gateway service, a personal blog service, an Internet knowledge service, an information system service of a company, and the like. Also, as shown in the class for the location 220, the user oriented information may be provided for various types of organizations or regions such as a home, a company, a bank, a school, a hospital, and the like.

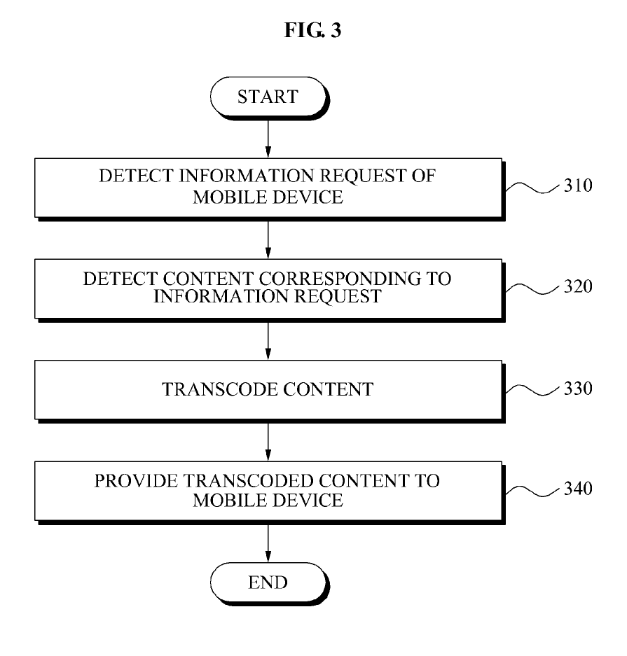

FIG. 3 is a flowchart illustrating a method of controlling a user oriented information system according to an embodiment of the present invention.

Referring to FIG. 3, the controlling method of FIG. 3 may be performed by the user oriented information system providing user oriented information according to a control of a processor according to an embodiment of the present invention. The user oriented information system may be constructed as shown in FIG. 1.

In operation 310, the user oriented information system may detect an access of a mobile device via an access management unit to detect an information request of the mobile device.

In operation 320, the user oriented information system may detect a content, stored in a peripheral content storage, via a content management unit. In this instance, the user oriented information system may receive, from the peripheral content storage, a content corresponding to the information request of the mobile device.

In operation 330, the user oriented information system may compare the received content with a profile of the mobile device. When transcoding is determined to be performed, the user oriented information system may transcode the content based on the profile of the mobile device. Here, a case where transcoding is determined to be performed may correspond to a case where the mobile device may not play the content.

In operation 340, the user oriented information system may transmit the transcoded content to the mobile device according to a policy of the access management unit. The policy of the access management unit indicates a policy for a management in order to maintain or suspend an access between the mobile device and an external network. For example, the policy of the access management unit may include a policy regarding the profile of the mobile device, a schedule, a payment, and the like.

### Example of Providing User Oriented Information According to an Embodiment of the Present Invention

Hereinafter, an example of providing user oriented information according to an embodiment of the present invention will be described.

1) A user of a mobile device may select user interest information that the user desires to receive, for example, weather, traffic, world time, stocks, advertisements of interesting products, and the like, and register the selected user interest information in the mobile device.

2) The mobile device may access a user oriented information system.

3) The user oriented information system may verify a profile of the mobile device and the registered user interest information.

4) The user oriented information system may retrieve a peripheral storage that maintains the user interest information.

5) The user oriented information system may receive a content, for example, weather, traffic, world time, stocks, advertisements of interesting products, and the like, corresponding to the user interest information from the peripheral storage that maintains the user interest information.

6) The user oriented information system may compare the profile of the mobile device with a capacity of the content or a type of a codec used for a creation of the content.

7) When the capacity of the content or the type of the codec is unsuitable for the mobile device, the user oriented information system may transcode the content to a form suitable for the mobile device.

8) The user oriented information system may provide the transcoded content to the mobile device.

9) When the content is in a form that can be executed or be displayed in the mobile device, the user oriented information system may provide the content to the mobile device without transcoding the content.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for user oriented information, the system comprising:
an access management unit that detects an access of a mobile device to receive a request for user interest information from the mobile device;
a content management unit that manages a content corresponding to the user interest information; and
a conversion management unit that converts the content to a form to be provided to the mobile device; and
a control unit that controls an overall operation of the user oriented information system.

2. The system of claim 1, further comprising:
a network interface unit that supports the access of the mobile device using the user oriented information system.

3. The system of claim 1, further comprising:
a profile management unit that detects and manages a profile of the mobile device.

4. The system of claim 3, wherein the content management unit and the profile management unit are provided in a form of a database.

5. The system of claim 1, wherein the conversion management unit performs real-time transcoding of a content corresponding to the user interest information to a form suitable for the mobile device or to a form desired by a user.

6. The system of claim 1, wherein the control unit compares the content corresponding to the user interest information with a profile of the mobile device, and when the content corresponding to the user interest information is in a form unsuitable for the mobile device, the control unit controls the conversion management unit to perform real-time transcoding of the content corresponding to the user interest information to a form suitable for the mobile device.

7. A method of controlling a user oriented information system that provides user oriented information to a mobile device of a user according to a control of a processor, the method comprising:
detecting an access of the mobile device;
receiving an information request from the mobile device;
receiving, from a peripheral content storage, a content corresponding to the information request of the mobile device;
comparing the content with a profile of the mobile device to transcode the content based on information of the profile, when transcoding is determined to be performed; and
providing the transcoded content to the mobile device.

8. The method of claim 7, wherein, when transcoding is determined to be performed, a capacity of the content or a type of a codec used for a creation of the content is unsuitable for the mobile device.

9. The method of claim 7, wherein the transcoding comprises determining a form desired by the user, based on the information of the profile, and transcoding the content to the form desired by the user, when the content is different from the form desired by the user.
